(19) United States
(12) Patent Application Publication
(10) Pub. No.: US 2012/0299323 A1
(43) Pub. Date: Nov. 29, 2012

(54) GARMENT CUSTOMIZATION VEHICLE

(76) Inventor: Qihan Li, Ningbo (CN)

(21) Appl. No.: 13/522,713

(22) PCT Filed: Jan. 21, 2011
(86) PCT No.: PCT/CN11/70448

§ 371 Date: Jul. 17, 2012

(30) Foreign Application Priority Data
Dec. 23, 2010 (CN) 201010608438.X

(51) Int. Cl. B60P 3/00; B60P 3/20; B60P 3/025

(52) U.S. Cl. 296/24.35; 296/24.4; 296/24.39

(57) ABSTRACT

This invention relates to a vehicle and discloses a garment customization vehicle, including a front compartment and a rear compartment. A middle separating board is disposed between the front compartment and the rear compartment. A high definition liquid crystal television display is disposed at the middle separating board. A computer host is disposed in the rear compartment. A retractable support pole is disposed at the computer host. A touch display is disposed at the retractable support pole. A camera capable of being rotated 360 degrees for providing video images of surroundings is disposed at the touch display. The touch display is connected with the computer host via the retractable support pole. The high definition liquid crystal television display, the computer host, the touch display, and the camera are electrically connected with each other. The structure of the invention is novel. Customers don't need to try on garments in person.

### BACKGROUND OF THE INVENTION

1. Field of the Invention

This invention relates to a vehicle and, more particularly, to a garment customization vehicle.

2. Description of the Related Art

At present, an image display, such as a liquid crystal display and so on, is usually installed in a business purpose vehicle in the market. With development of society, people's pace of life is faster and faster, particularly the frequency of business meetings is higher and higher, and even business negotiations need to be finished in the vehicle sometimes. However, the existing garment customization system generally has a large volume and occupies a large space. Generally, the function of the image display installed in the business purpose vehicle is very simple, which is hard to meet the requirement of finishing garment customization in the business purpose vehicle.

### BRIEF SUMMARY OF THE INVENTION

In the prior art, the function of an image display in a business purpose vehicle is very simple, which is hard to meet the requirement of finishing garment customization in the business purpose vehicle. According to the disadvantage, this invention provides a garment customization vehicle. A garment customization system is designed to be in the business purpose vehicle thus not to occupy too much vehicle space, and customers don't need to try on garments in person. Therefore, fitting process is time-saving and intuitive, and the operation is simple and convenient.

To solve the above technical problems, the invention provides following technical solutions:

A garment customization vehicle includes a front compartment and a rear compartment. A middle separating board is disposed between the front compartment and the rear compartment. A high definition liquid crystal television display is disposed at the middle separating board. A computer host is disposed in the rear compartment. A retractable support pole is disposed at the computer host. A touch display is disposed at the retractable support pole. A camera capable of being rotated 360 degrees for providing video images of surroundings is disposed at the touch display. The touch display is connected with the computer host via the retractable support pole. The high definition liquid crystal television display, the computer host, the touch display, and the camera are electrically connected with each other.

A rotatable shaft is disposed between the middle separating board and the high definition liquid crystal television display, and the high definition liquid crystal television display can be rotated 90 degrees along the clockwise/counter-clockwise direction via the rotatable shaft. Therefore, effects of garment fittings can be displayed in real time for different customers, and the operation is simple and convenient.

An independent air-conditioning system is disposed at a side wall of the rear compartment.

An office desk is disposed in the rear compartment, and a five-hole outlet is disposed at a panel of the office desk.

An office panel is disposed at a side wall of the rear compartment, and one end of the office panel is connected to the side wall of the real compartment via a hinge. When the office panel is not in use, the office panel can be folded to save space of the compartment, and it's convenient for use.

A pair of leather seats is disposed in the front compartment, and a fire extinguisher is disposed between the two leather seats.

A protrudent platform is disposed at the touch display, a flexible metal tube is disposed at the protrudent platform, and the camera is fixed to the protrudent platform via the flexible metal tube. When in use, the camera can be bent and rotated at any angle via the flexible metal tube.

A freezer is disposed in the rear compartment.

Garment computer-aided design (CAD) automatic typesetting system software is installed in the computer host. The garment CAD automatic typesetting system software can be directly connected with an automatic cutting table system of a designated factory to operate.

Images of the customers in the customization vehicle can be displayed on the high definition liquid crystal television display via shooting of the camera. The customers can select different kinds of garment information by operating a control key on the touch display to directedly obtain related product information, such as production places of garments, texture, matching effects and so on, and the use is very convenient.

Since the invention adopts the above technical solutions, the invention has obvious technical effects.

The structure in the invention is novel. The customers don't need to try on garments in person, and the customers can directly select more garment information by touching the touch display and enjoy more and better service. The fitting process is time-saving and intuitive, and the operation is very convenient, greatly improving the efficiency of the fitting.

### BRIEF DESCRIPTION OF THE DRAWINGS

FIG. 1 is a schematic diagram showing a structure according to this invention; and

FIG. 2 is an enlarged diagram showing a partial structure according to the invention.

### DETAILED DESCRIPTION OF THE INVENTION

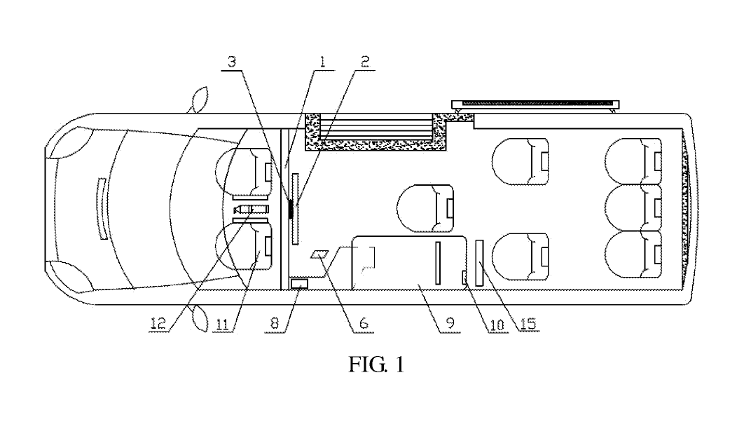

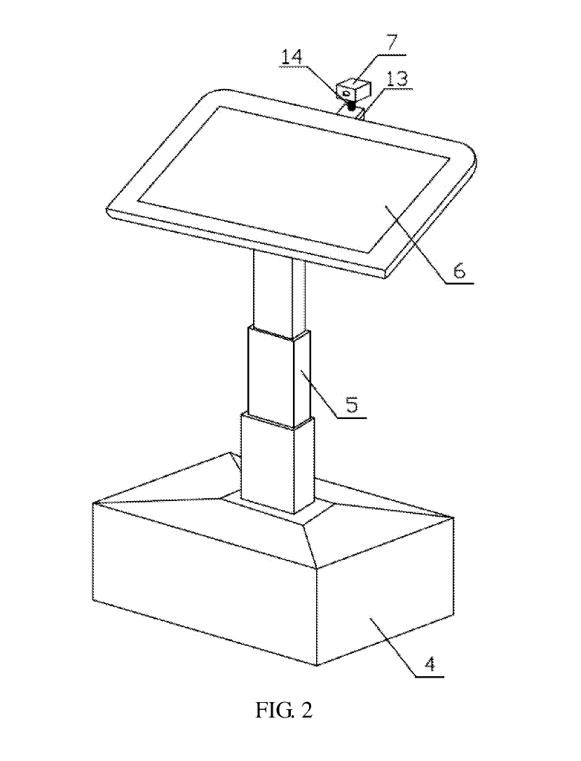

The following further describes this invention in detail combining with FIG. 1, FIG. 2, and embodiments.

### Embodiment 1

As shown in FIG. 1 and FIG. 2, a garment customization vehicle includes a front compartment and a rear compartment. A middle separating board 1 is disposed between the front compartment and the rear compartment. A high definition liquid crystal television display 2 is disposed at the middle separating board 1. A computer host 4 is disposed in the rear compartment. Garment computer-aided design (CAD) automatic typesetting system software is installed in the computer host 4. The garment CAD automatic typesetting system software can be directly connected with an automatic cutting table system of a designated factory to operate. A retractable support pole 5 is disposed at the computer host 4. A touch display 6 is disposed at the retractable support pole 5. A camera 7 capable of being rotated 360 degrees for providing video images of surroundings is disposed at the touch display 6. The touch display 6 is connected with the computer host 4 via the retractable support pole 5. The high definition liquid crystal television display 2, the computer host 4, the touch display 6, and the camera 7 are electrically connected with each other.

A rotatable shaft 3 is disposed between the middle separating board 1 and the high definition liquid crystal television display 2, and the high definition liquid crystal television display 2 can be rotated 90 degrees along the clockwise/counter-clockwise direction via the rotatable shaft 3.

An independent air-conditioning system 8 is disposed at a side wall of the rear compartment.

An office desk 9 is disposed in the rear compartment, and a five-hole outlet 10 is disposed at a panel of the office desk 9, providing the power outlet for the electric appliance needed by the customers in negotiation procedure. It's safe and convenient.

A pair of leather seats 11 is disposed in the front compartment, and a fire extinguisher 12 is disposed between the two leather seats 11.

A protrudent platform 13 is disposed at the touch display 6, a flexible metal tube 14 is disposed at the protrudent platform 13, and the camera 7 is fixed to the protrudent platform 13 via the flexible metal tube 14. When in use, the camera 7 can be bent and rotated at any angle via the flexible metal tube 14.

A freezer 15 is disposed in the rear compartment.

### Embodiment 2

As shown in FIG. 1 and FIG. 2, a garment customization vehicle includes a front compartment and a rear compartment. A middle separating board 1 is disposed between the front compartment and the rear compartment. A high definition liquid crystal television display 2 is disposed at the middle separating board 1. A computer host 4 is disposed in the rear compartment. Garment computer-aided design (CAD) automatic typesetting system software is installed in the computer host 4. The garment CAD automatic typesetting system software can be directly connected with an automatic cutting table system of a designated factory to operate. A retractable support pole 5 is disposed at the computer host 4. A touch display 6 is disposed at the retractable support pole 5. A camera 7 capable of being rotated 360 degrees for providing video images of surroundings is disposed at the touch display 6. The touch display 6 is connected with the computer host 4 via the retractable support pole 5. The high definition liquid crystal television display 2, the computer host 4, the touch display 6, and the camera 7 are electrically connected with each other.

A rotatable shaft 3 is disposed between the middle separating board 1 and the high definition liquid crystal television display 2, and the high definition liquid crystal television display 2 can be rotated 90 degrees along the clockwise/counter-clockwise direction via the rotatable shaft 3.

An independent air-conditioning system 8 is disposed at a side wall of the rear compartment.

An office panel is disposed at a side wall of the rear compartment, and one end of the office panel is connected to the side wall of the real compartment via a hinge.

A pair of leather seats 11 is disposed in the front compartment, and a fire extinguisher 12 is disposed between the two leather seats 11.

A protrudent platform 13 is disposed at the touch display 6, a flexible metal tube 14 is disposed at the protrudent platform 13, and the camera 7 is fixed to the protrudent platform 13 via the flexible metal tube 14. When in use, the camera 7 can be bent and rotated at any angle via the flexible metal tube 14.

A freezer 15 is disposed in the rear compartment.

Images of the customers in the garment customization vehicle can be displayed on the high definition liquid crystal television display via shooting of the camera. The customers can select different kinds of garment information by operating a control key on the touch display to directedly obtain related product information, such as production places of garments, texture, matching effects and so on, and the use is very convenient.

The structure in the invention is novel. The customers don't need to try on garments in person, and the customers can directly select more garment information by touching the touch display and enjoy more and better service. The fitting process is time-saving and intuitive, and the operation is very convenient, greatly improving the efficiency of the fitting.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

In a word, the above mentioned are just preferred embodiments of the invention. Therefore, any equivalent changes and modifications made according to the scope of the invention need to be included within the protection scope of the invention.

1. A garment customization vehicle including a front compartment and a rear compartment, comprising:
a middle separating board (1) disposed between the front compartment and the rear compartment; a high definition liquid crystal television display (2) disposed at the middle separating board (1); a computer host (4) disposed in the rear compartment; a retractable support pole (5) disposed at the computer host (4); a touch display (6) disposed at the retractable support pole (5); and a camera (7) capable of being rotated 360 degrees for providing video images of surroundings disposed at the touch display (6), the touch display (6) connected with the computer host (4) via the retractable support pole (5), the high definition liquid crystal television display (2), the computer host (4), the touch display (6), and the camera (7) electrically connected with each other.

2. The garment customization vehicle according to claim 1, wherein a rotatable shaft (3) is disposed between the middle separating board (1) and the high definition liquid crystal television display (2), and the high definition liquid crystal television display (2) can be rotated 90 degrees along the clockwise/counter-clockwise direction via the rotatable shaft (3).

3. The garment customization vehicle according to claim 1, wherein an independent air-conditioning system (8) is disposed at a side wall of the rear compartment.

4. The garment customization vehicle according to claim 1, wherein an office desk (9) is disposed in the rear compartment, and a five-hole outlet (10) is disposed at a panel of the office desk (9).

5. The garment customization vehicle according to claim 1, wherein an office panel is disposed at a side wall of the rear compartment, and one end of the office panel is connected to the side wall of the real compartment via a hinge.

6. The garment customization vehicle according to claim 1, wherein a pair of leather seats (11) is disposed in the front compartment, and a fire extinguisher (12) is disposed between the two leather seats (11).

7. The garment customization vehicle according to claim 1, wherein a protrudent platform (13) is disposed at the touch display (6), a flexible metal tube (14) is disposed at the protrudent platform (13), and the camera (7) is fixed to the protrudent platform (13) via the flexible metal tube (14).

8. The garment customization vehicle according to claim 1, wherein a freezer (15) is disposed in the rear compartment.

9. The garment customization vehicle according to claim 1, wherein garment computer-aided design (CAD) automatic typesetting system software is installed in the computer host (4).
